(19) United States
(12) Patent Application Publication
(10) Pub. No.: US 2023/0142081 A1
(43) Pub. Date: May 11, 2023

(54) VOICE CAPTCHA

(71) Applicant: NUANCE COMMUNICATIONS, INC., Burlington, MA (US)

(72) Inventors: John Benjamin FISLER, Belle Vernon, PA (US); Nikos POLIS, West Orange, NJ (US); Christopher JENNISON, Nashua, NH (US); Andrew MATKIN, Bolton, MA (US); David ARDMAN, Quebec (CA); Nirvana TIKKU, Brooklyn, NY (US)

(73) Assignee: NUANCE COMMUNICATIONS, INC., Burlington, MA (US)

(21) Appl. No.: 17/523,024

(22) Filed: Nov. 10, 2021

(51) Int. Cl. G06F 21/32; G10L 17/04; G10L 17/24; G10L 25/72

(52) U.S. Cl. CPC G06F 21/32; G10L 17/04; G10L 17/24; G10L 25/72; G06F 2221/2133

(57) ABSTRACT

A method of Completely Automated Public Turing test to tell Computers and Humans Apart (CAPTCHA) includes: recording, by a voice CAPTCHA module, a speech spoken by a user; determining, by a voice biometric service (VBS), whether a voiceprint matching the user's speech exists; and if a voiceprint matching the user's speech exists, verifying the user as a human user by the VBS. If a voiceprint matching the user's speech does not exist, the VBS i) generates a unique voiceprint for the user based on the user's speech, and/or ii) determines whether the user's speech is at least one of a synthetically generated speech and a previously recorded audio being played back. The user can perform a guest checkout without logging into the voice CAPTCHA module, in which case the VBS compares previously used voiceprints to the user's speech.

### BACKGROUND OF THE DISCLOSURE

### 1. Field of the Disclosure

The present disclosure relates to an automated method for verifying that a user of a system is a human, and relates more particularly to a voice-based implementation of Completely Automated Public Turing test to tell Computers and Humans Apart (CAPTCHA).

### 2. Description of the Related Art

In the modern Internet environment, digital enterprise platforms, e.g., finance, retail and/or travel websites, need to contend with bots, i.e., automated software applications programmed to do specific tasks much faster than can be performed by human users. Bots, which usually operate over a network, often imitate or replace a human user's behavior to perform malicious activities, e.g., hacking user accounts, scanning the web for contact information, etc. Examples of hots include web crawlers (which scan webpage contents on the Internet), social bots (which operate on social media platforms), chatbots (which simulate human responses in conversations) and malicious hots (which can send spam, scrape content, and/or perform credential stuffing).

One of the techniques for combatting hots is using completely automated public Turing test to tell computers and humans apart (CAPTCHA), which is a challenge-response mechanism configured to distinguish between a bot and a human. Conventional CAPTCHAs utilize text and/or image as bases for the challenge-response mechanism, which CAPTCHAs are increasingly being solved by hots and farms faster than the text and/or images can load on user's browsers, and the conventional CAPTCHAs are not able to detect when a single entity has solved the posed challenge multiple times, thus defeating the CAPTCHAs.

Therefore, there is a need to provide an improved CAPTCHA which can effectively distinguishes between a bot and a human.

### SUMMARY OF THE DISCLOSURE

According to an example embodiment of a method and a system for a voice CAPTCHA according to the present disclosure, a synthetically generated speech is distinguished from a natural human voice.

According to an example embodiment of the method and the system for a voice CAPTCHA according to the present disclosure, a user's voiceprint is created and associated with the user for authentication.

According to an example embodiment of the method and the system for a voice CAPTCHA according to the present disclosure, once a user logs into an account of the user in a system having the voice CAPTCHA functionality, the system checks whether the user's voiceprint already exists, and if not, the system records the user's speech to generate a unique voiceprint of the user.

According to an example embodiment of the method and the system for a voice CAPTCHA according to the present disclosure, once a user logs into an account of the user in a system having the voice CAPTCHA functionality, the system checks whether the user's voiceprint already exists, and if so, the system authenticates the user's voice by matching it to the user's voiceprint.

According to an example embodiment of the method and the system for a voice CAPTCHA according to the present disclosure, in the case a user performs a “guest checkout” (e.g., perform a purchase transaction) without logging into an account of the user in a system having the voice CAPTCHA functionality, the system determines whether the user is at least one of i) unique, ii) human, and iii) speaking live.

According to an example embodiment of the method and the system for a voice CAPTCHA according to the present disclosure, in the case a user performs a “guest checkout” without logging into an account of the user in a system having the voice CAPTCHA functionality, the system will try to match the user's voice to previous voices used for checkouts and/or those voices that have been enrolled already to determine, e.g., whether the user has previously purchased the same item.

### BRIEF DESCRIPTION OF THE FIGURES

FIG.1a is a schematic diagram of various components of an example system for implementing the voice CAPTCHA method according to the present disclosure.

FIG. 1b illustrates an overall signal flow among various components of an example system for implementing the voice CAPTCHA method according to the present disclosure.

FIG. 2 illustrates an example signal flow in an example system for implementing the voice CAPTCHA method for the case in which no voiceprint for the speaker is available.

FIG. 3 illustrates an example signal flow in an example system for implementing the voice CAPTCHA method for the case in which a voiceprint for the speaker is available.

FIG, 4 illustrates an example signal flow in an example system for implementing the voice CAPTCHA method for the case in which the user performs a “guest checkout”.

### DETAI LED DESCRIPTION

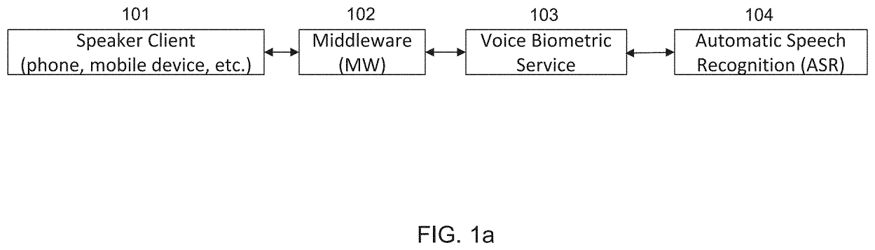

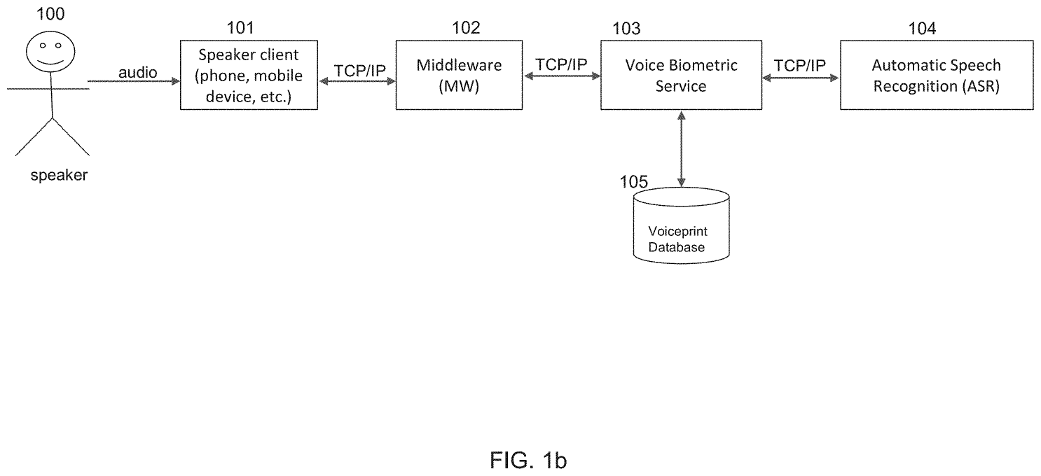

FIG. 1a is a schematic diagram of various components of an example system for implementing the voice CAPTCHA method according to the present disclosure. FIG. 1a shows a speaker client 101 (e.g., phone, mobile device, etc., which can include a voice CAPTCHA according to the present description), a middleware 102 (which is a software that lies between an operating system/database and the applications running on it, enabling communication and data management for distributed applications), a voice biometric service module 103, and an automatic speech recognition (ASR) module 104.

FIG. 1b illustrates an overall signal flow among various components of an example system for implementing the voice CAPTCHA method according to the present disclosure. The example overall system shown in FIG. 1b is substantially similar to the system shown in FIG. 1a, i.e., the speaker client 101, the middleware (MW) 102, the voice biometric service module 103, and the automatic speech recognition (ASR) module 104. The overall system shown in FIG. 1b additionally includes a voiceprint database 105. As shown in FIG. 1b, the speech audio from a speaker 100 is captured by the speaker client 101 (e.g., phone, mobile device, etc.). The middleware 102 is positioned between the speaker client 101 and the voice biometric service module 103, the communication (e.g., for voice CAPTCHA implementation) among which components can be implemented using transmission control protocol (TCP) and/or Internet protocol (IP). In the example embodiment shown in FIG, lb, the voice biometric service module 103 is operatively connected to the automatic speech recognition (ASR) module 104 (e.g., via TCP/IP) and the voiceprint database 105.

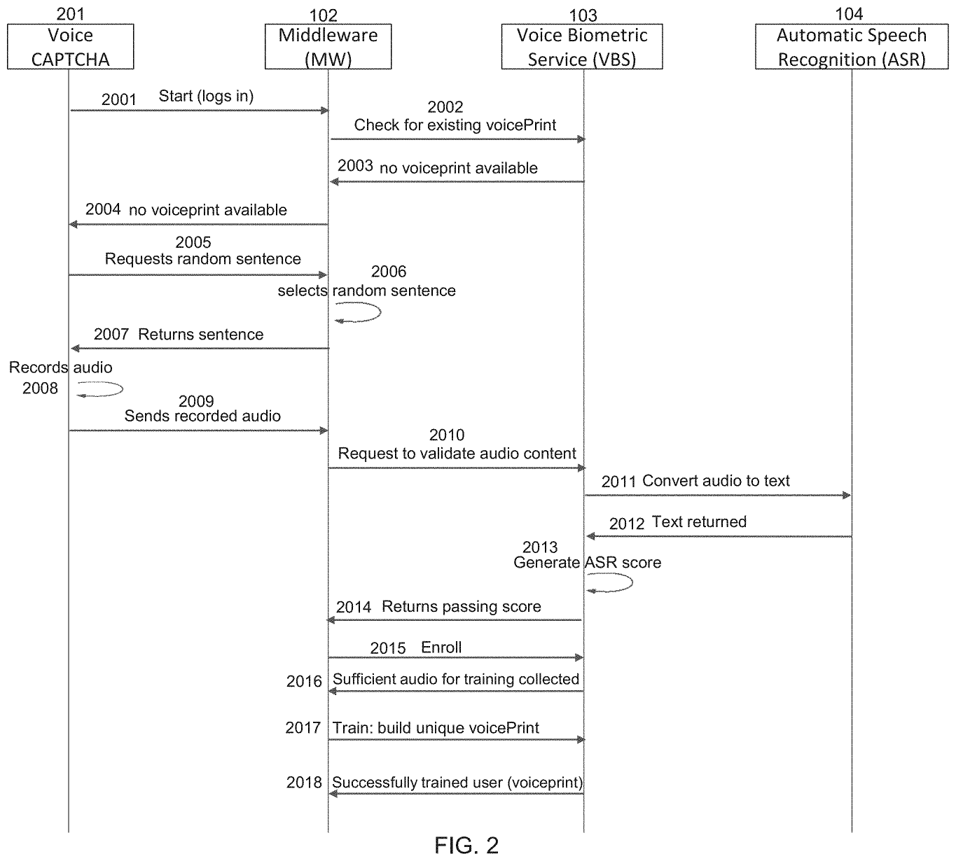

FIG. 2 illustrates an example signal flow in a system for implementing the voice CAPTCHA method for the case in which no voiceprint for the user is available. The system shown in FIG. 2 includes a voice CAPTCHA module 201, the middleware (MW) 102, the voice biometric service module (VBS) 103, and the automatic speech recognition (ASR) module 104. As shown by the process arrow 2001, upon being presented with a login screen menu, the user logs into the voice CAPTCHA 201 (es., using previously established login credentials for the user's account), which login information is sent to the middleware 102. The middleware 102 checks with the voice biometric service 103 for an existing voiceprint (e.g., stored in the voiceprint database 105 shown in FIG. 1b) for the user, as shown by the process arrow 2002. The voice biometric service 103 responds by indicating that no voiceprint for the user exists, as shown by the process arrow 2003. The middleware 102 relays to the voice CAPTCHA 201 the information indicating that no voiceprint for the user exists, as shown by the process arrow 2004. The voice CAPTCHA 201 requests the MW 102 to send a random sentence (or a word, or a sentence fragment), as shown by the process arrow 2005. The middleware 102 selects a random sentence, as shown by the process arrow 2006, and then forwards the selected random sentence to the voice CAPTCHA 201, as shown by the process arrow 2007.

Continuing with FIG. 2, the voice CAPTCHA 201 records the audio of the selected random sentence as spoken by the user, as shown by the process arrow 2008. Next, as shown by the process arrow 2009, the voice CAPTCHA 201 sends the recorded audio to the MW 102. The MW 102 sends to the VBS103 a request to validate the audio content, as shown by the process arrow 2010. The VBS 103 then sends a request to the ASR 104 to convert the audio to text, as shown by the process arrow 2011. As shown by the process arrow 2012, the ASR 104 returns the text output to the VBS 103. The VBS generates an ASR score, as shown by the process arrow 2013, and if the ASR score is above a predetermined passing score, the VBS then sends the passing score to the MW 102, as shown by the process arrow 2014. The MW 102 then sends a request to enroll the user with the VBS 103, as shown by the process arrow 2015. Once the VBS 103 sends to the MW 102 an indication that sufficient audio material from the user has been collected for training, as shown by the process arrow 2016, the MW 102 sends a request to the VBS 103 (as shown by the process arrow 2017) to start the training process to build a unique voiceprint. Once the training process for the voiceprint of the user has been completed, the VBS 103 sends to the MW 102 an indication that the unique voiceprint for the user has been successfully trained, as shown by the process arrow 2018. The unique voiceprint for the user can be used for future voice-based CAPTCHA verification of the user as a registered human user.

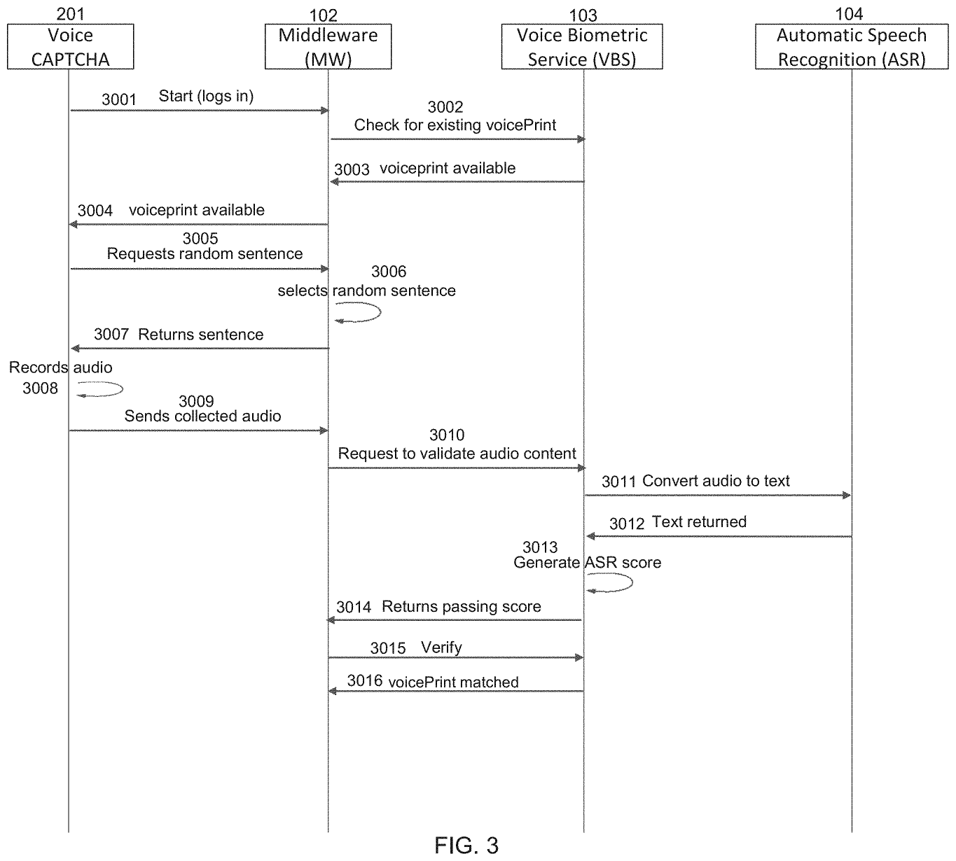

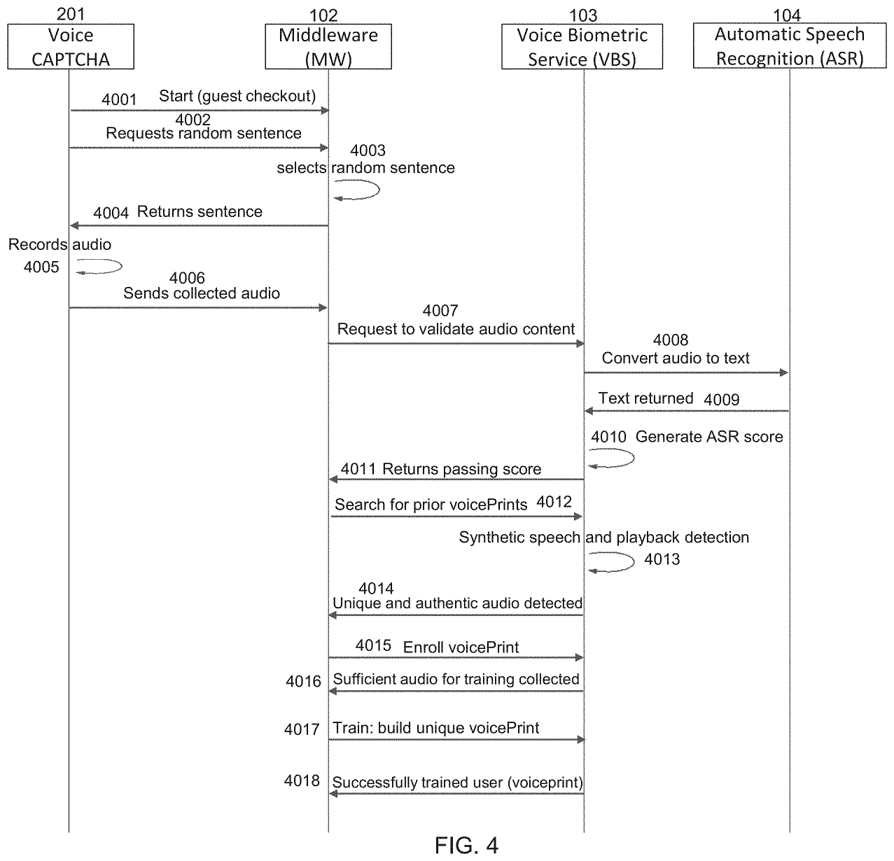

FIG. 3 illustrates an example signal flow in a system for implementing the voice CAPTCHA method for the case in which a voiceprint for the user is available, The system shown in FIG. 3 includes a voice CAPTCHA module 201, the middleware (MW) 102, the voice biometric service module (VBS) 103, and the automatic speech recognition (ASR) module 104. As shown by the process arrow 3001, the user logs into the voice CAPTCHA 201 (e.g., using previously established login credentials for the user's account), which login information is sent to the middleware 102. The middleware 102 checks with the voice biometric service 103 for an existing voiceprint (e.g., stored in the voiceprint database 105 shown in FIG. 1b) for the user, as shown by the process arrow 3002. The voice biometric service 103 responds by indicating that a voiceprint for the user exists, as shown by the process arrow 3003. The middleware 102 relays to the voice CAPTCHA 201 the information indicating that a voiceprint for the user exists, as shown by the process arrow 3004. The voice CAPTCHA 201 requests the MW 102 to send a random sentence, as shown by the process arrow 3005. The middleware 102 selects a random sentence (or a word, or a sentence fragment), as shown by the process arrow 3006, and then forwards the selected random sentence to the voice CAPTCHA 201, as shown by the process arrow 3007.

Continuing with FIG. 3, the voice CAPTCHA 201 records the audio of the selected random sentence as spoken by the user, as shown by the process arrow 3008. Next, as shown by the process arrow 3009, the voice CAPTCHA 201 sends the recorded audio to the MW 102. The MW 102 sends to the VBS103 a request to validate the audio content, as shown by the process arrow 3010, The VBS 103 then sends a request to the ASR 104 to convert the audio to text, as shown by the process arrow 3011. As shown by the process arrow 3012, the ASR 104 returns the text output to the VBS 103. The VBS generates an ASR score, as shown by the process arrow 3013, and if the ASR score is above a predetermined passing score, the IBS then sends the passing score to the MW 102, as shown by the process arrow 3014. The MW 102 then sends to the VBS 103 a request to verify the user by comparing the user's recorded audio with the available voiceprint, as shown by the process arrow 3015. Once the VBS 103 has verified that the user's recorded audio matches the available voiceprint of the user, the VBS 103 sends to the MW 102 an indication of the match, as shown by the process arrow 3016. In this manner, the user of the voice CAPTCHA is verified as a registered human user.

FIG. 4 illustrates an example signal flow in an example system for implementing the voice CAPTCHA method for the case in which the user performs a “guest checkout,” i.e., the user does not have an account for the voice CAPTCHA 201. The system shown in FIG. 4 includes a voice CAPTCHA module 201, the middleware (MW) 102, the voice biometric service module (VBS) 103, and the automatic speech recognition (ASR) module 104. As shown by the process arrow 4001, the user starts the guest checkout process using the voice CAPTCHA 201, which information is sent to the middleware 102. The voice CAPTCHA 201 then sends to the middleware 102 a request for a random sentence, as shown by the process arrow 4002. The MW 102 selects a random sentence (or a word, or a sentence fragment), as shown by the process arrow 4003, then sends the selected sentence to the voice CAPTCHA 201, as shown by the process arrow 4004. The voice CAPTCHA 201 records the audio of the selected random sentence as spoken by the user, as shown by the process arrow 4005. Next, as shown by the process arrow 4006, the voice CAPTCHA 201 sends the recorded audio to the MW 102.

Continuing with FIG. 4. the MW 102 sends to the VBS103 a request to validate the audio content, as shown by the process arrow 4007. The VBS 103 then sends a request to the ASR 104 to convert the audio to text, as shown by the process arrow 4008. As shown by the process arrow 4009, the ASR. 104 returns the text output to the VBS 103. The VBS 103 generates an ASR score, as shown by the process arrow 4010, and if the ASR score is above a predetermined passing score, the VBS then sends the passing score to the MW 102, as shown by the process arrow 4011. The MW 102 then sends a request to the VBS 103 to initiate a search for previously used voiceprints (e.g., previously used guest checkout voices, and/or previously enrolled voiceprints) matching the audio recorded by the user, as shown by the process arrow 4012. In addition, the VBS checks whether the user's spoken audio is a synthetically generated speech and/or previously recorded audio being played back, as shown by the process arrow 4013. In this manner, the VBS 103 determines whether the user is at least one of i) unique, ii) human, and/or iii) speaking live. The VBS 103 then sends an indication to the MW 102 that a unique and authentic human audio has been detected from the user, as shown by the process arrow 4014

The MW 102 then sends a request to enroll the user with the VBS 103, as shown by the process arrow 4015. Once the VBS 103 sends to the MW 102 an indication that sufficient audio material from the user has been collected for training, as shown by the process arrow 4016, the MW 102 sends a request to the VBS 103 (as shown by the process arrow 4017) to start the training process to build a unique voiceprint. Once the training process for the voiceprint of the user has been completed, the VBS 103 sends to the MW 102 an indication that the unique voiceprint for the user has been successfully trained, as shown by the process arrow 4018.

As a summary, several examples of the method and the system according to the present disclosure are provided.

A first example of the method according to the present disclosure provides a method of Completely Automated Public Turing test to tell Computers and Humans Apart (CAPTCHA), comprising: recording, by a voice CAPTCHA module, a speech spoken by a user; determining, by a voice biometric service (VBS), whether a voiceprint matching the user's speech exists; and if a voiceprint matching the user's speech exists, verifying the user as a human user by the VBS.

A second example of the method modifying the first example of the method, the second method further comprising: if a voiceprint matching the user's speech does not exist, generating by the VBS a unique voiceprint for the user based on the user's speech.

A third example of the method modifying the first example of the method, the third method further comprising: if a voiceprint matching the user's speech does not exist, determining by the VBS whether the user's speech is at least one of a synthetically generated speech and a previously recorded audio being played back.

A fourth example of the method modifying the first example of the method, the fourth method further comprising: presenting, by the voice CAPTCHA module, a login screen to the user; wherein the VBS determines whether the voiceprint matching the user's speech exists after the user has logged in.

A fifth example of the method modifying the second example of the method, the fifth method further comprising: presenting, by the voice CAPTCHA module, a login screen to the user; wherein the VBS determines whether the voiceprint matching the user's speech exists after the user has logged in.

In a sixth example of the method modifying the third example of the method, the voice CAPTCHA module enables the user to perform a guest checkout without logging into the voice CAPTCHA module.

A seventh example of the method modifying the sixth example of the method, the seventh method further comprising: comparing, by the VBS, previously used voiceprints to the user's speech.

An eighth example of the method modifying the second example of the method, the eight method further comprising: if a voiceprint matching the user's speech does not exist, determining by the \IBS whether the user's speech is one of a synthetically generated speech and a previously recorded audio being played back.

In a ninth example of the method modifying the eighth example of the method, if the user's speech is not one of a synthetically generated speech and a previously recorded audio being played back, the VBS determines the user's speech to be a unique and authentic human voice.

In a tenth example of the method modifying the ninth example of the method, the unique voiceprint for the user is generated by the VBS after determining the user's speech is a unique and authentic human voice.

A first example of the system according to the present disclosure provides a system for implementing a method of Completely Automated. Public Turing test to tell Computers and Humans Apart (CAPTCHA), comprising: a voice CAPTCHA module configured to record a speech spoken by a user; and a voice biometric service (VBS) configured to: i) determine whether a voiceprint matching the user's speech exists, and ii) if a voiceprint matching the user's speech exists, verifying the user as a human user.

In a second example of the system modifying the first example of the system, the VBS is configured to generate a unique voiceprint for the user based on the user's speech if a voiceprint matching the user's speech does not exist.

In a third example of the system modifying the first example of the system, if a voiceprint matching the user's speech does not exist, the VBS is configured to determine whether the user's speech is at least one of a synthetically generated speech and a previously recorded audio being played back.

In a fourth example of the system modifying the first example of the system, the voice CAPTCHA module is configured to present a login screen to the user; and the VBS is configured to determine whether the voiceprint matching the user's speech exists after the user has logged in.

In a fifth example of the system modifying the second example of the system, the voice CAPTCHA module is configured to present a login screen to the user; and the VBS is configured to determine whether the voiceprint matching the user's speech exists after the user has logged in.

In a sixth example of the system modifying the third example of the system, the voice CAPTCHA module is configured to enable the user to perform a guest checkout without logging into the voice CAPTCHA module.

In a seventh example of the system modifying the sixth example of the system, the VBS is configured to compare previously used voiceprints to the user's speech.

In an eighth example of the system modifying the second example of the system, if a voiceprint matching the user's speech does not exist, the VBS is configured to determine whether the user's speech is at least one of a synthetically generated speech and a previously recorded audio being played back.

In a ninth example of the system modifying the eighth example of the system, if the user's speech is not one of a synthetically generated speech and a previously recorded audio being played back, the VBS is configured to determine the user's speech to be a unique and authentic human voice.

In a tenth example of the system modifying the ninth example of the system, the VBS is configured to generate the unique voiceprint for the user after determining the user's speech is a unique and authentic human voice.

What is claimed is:

1. A method of Completely Automated Public Turing test to tell Computers and Humans Apart (CAPTCHA), comprising:
recording, by a voice CAPTCHA module, a speech spoken by a user;
determining, by a voice biometric service (VBS), whether a voiceprint matching the user's speech exists; and
if a voiceprint matching the user's speech exists, verifying the user as a human user by the VBS.

2. The method of claim 1, further comprising:
if a voiceprint matching the user's speech does not exist, generating by the VBS a unique voiceprint for the user based on the user's speech.

3. The method of claim 1, further comprising:
if a voiceprint matching the user's speech does not exist, determining by the VBS whether the user's speech is at least one of a synthetically generated speech and a previously recorded audio being played back.

4. The method of claim 1, further comprising:
presenting, by the voice CAPTCHA module, a login screen to the user;
wherein the VBS determines whether the voiceprint matching the user's speech exists after the user has logged in.

5. The method of claim 2, further comprising:
presenting, by the voice CAPTCHA module, a login screen to the user;
wherein the VBS determines whether the voiceprint matching the user's speech exists after the user has logged in.

6. The method of claim 3, wherein the voice CAPTCHA module enables the user to perform a guest checkout without logging into the voice CAPTCHA module.

7. The method of claim 6, further comprising:
comparing, by the VBS, previously used voiceprints to the user's speech.

8. The method of claim 2, further comprising:
if a voiceprint matching the user's speech does not exist, determining by the VBS whether the user's speech is one of a synthetically generated speech and a previously recorded audio being played back.

9. The method of claim 8, wherein if the user's speech is not one of a synthetically generated speech and a previously recorded audio being played back, the VBS determines the user's speech to be a unique and authentic human voice.

10. The method of claim 9, wherein the unique voiceprint for the user is generated by the VBS after determining the user's speech is a unique and authentic human voice.

11. A system for implementing a method of Completely Automated Public Turing test to tell Computers and Humans Apart (CAPTCHA), comprising:
a voice CAPTCHA module configured to record a speech spoken by a user; and.
a voice biometric service (VBS) configured to: i) determine whether a voiceprint matching the user's speech exists, and ii) if a voiceprint matching the user's speech exists, verifying the user as a human user.

12. The system of claim 11, wherein:
the VBS is configured to generate a unique voiceprint for the user based on the user's speech if a voiceprint matching the user's speech does not exist.

13. The system of claim 11, wherein:
if a voiceprint matching the user's speech does not exist, the VBS is configured to determine whether the user's speech is at least one of a synthetically generated speech and a previously recorded audio being played back.

14. The system of claim 11, wherein:
the voice CAPTCHA module is configured to present a login screen to the user; and
the VBS is configured to determine whether the voiceprint matching the user's speech exists after the user has logged in.

15. The system of claim 12. wherein:
the voice CAPTCHA module is configured to present a login screen to the user; and
the TBS is configured to determine whether the voiceprint matching the user's speech exists after the user has logged in.

16. The system of claim 13, wherein:
the voice CAPTCHA. module is configured to enable the user to perform a guest checkout without logging into the voice CAPTCHA module.

17. The system of claim 16, wherein:
the VI3S is configured to compare previously used voiceprints to the user's speech.

18. The system of claim 12, wherein:
if a voiceprint matching the user's speech does not exist, the VBS is configured to determine whether the user's speech is at least one of a synthetically generated speech and a previously recorded audio being played back.

19. The system of claim 18, wherein:
if the user's speech is not one of a synthetically generated speech and a previously recorded audio being played back, the VBS is configured to determine the user's speech to be a unique and authentic human voice.

20. The system of claim 19, wherein:
the VBS is configured to generate the unique voiceprint for the user after determining the user's speech is a unique and authentic human voice.
